(19) United States
(12) Patent Application Publication
(10) Pub. No.: US 2010/0239168 A1
(43) Pub. Date: Sep. 23, 2010

(54) SEMI-TIED COVARIANCE MODELLING FOR HANDWRITING RECOGNITION

(75) Inventors: Qiang Huo, Beijing (CN); Yongqiang Wang, Hefei (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/407,791

(22) Filed: Mar. 20, 2009

(51) Int. Cl. G06K 9/18

(52) U.S. Cl. 382/185; 382/186

(57) ABSTRACT

Described is a technology by which handwriting recognition is performed using a semi-tied covariance modeling (STC) that requires far less memory than other models such as MQDF. Offline training, such as via maximum likelihood and/or minimum classification error techniques, provides classification data. The classification data includes semi-tied transforms that are shared by classes, along with a class-dependent diagonal matrix and a mean vector corresponding to each class. The semi-tied transforms and class-dependent diagonal matrices are obtained by processing a precision matrix for each class. In online recognition, received handwritten input (e.g., an East Asian character) is classified into a class, based upon the class-dependent diagonal matrices and the semi-tied transforms, by a STC recognizer that outputs similarity scores for candidates and a decision rule that selects the most likely class.

### CROSS-REFERENCE TO RELATED APPLICATION

The present application is related to copending U.S. patent application Ser. No. ______ (attorney docket no. 325005.01) entitled “Precision Constrained Gaussian Model for Handwriting Recognition,” filed concurrently herewith, assigned to the assignee of the present application, and hereby incorporated by reference.

### BACKGROUND

Handwriting recognition systems, particularly for East Asian languages such as Chinese, Japanese, and Korean, need to recognize thousands of characters. Contemporary recognition systems typically include a character classifier constructed based upon a modified quadratic discriminant function (MQDF). In general, the MQDF-based approach assumes that the feature vectors of each character class can be modeled by a Gaussian distribution with a mean vector and a full covariance matrix.

In order to achieve reasonably high recognition accuracy, a large enough number of the leading eigenvectors of the covariance matrix have to be stored. This requires a significant amount of memory to store the relevant model parameters. In general, the more memory, the better the recognition accuracy.

As a result, recognition accuracy is reduced when implementing an MQDF-based recognizer in a computing device having limited memory, such as a personal digital assistant, a cellular telephone, an embedded device and so forth. What is needed is a way to improve the accuracy versus memory tradeoff that is inherent in the MQDF-based approach, whereby devices having lesser amounts of memory can provide improved recognition accuracy.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which handwriting recognition is performed using semi-tied covariance (STC) modeling that requires far less memory than other models such as MQDF. In one aspect, semi-tied transforms that are shared by classes, along with class-dependent diagonal matrices (one class-dependent diagonal matrix corresponding to each class), are computed and maintained. Received handwritten input is classified into a class based upon the semi-tied transforms, the class-dependent diagonal matrices and mean vectors.

In one aspect, the semi-tied transforms and class-dependent diagonal matrices are obtained by processing data corresponding to a covariance matrix, that is, a precision matrix, for each class, which may be accomplished in part by maximum likelihood and/or minimum classification error training. These classification data are loaded into a computing device, such as a mobile device containing a STC modeling-based recognizer e.g., configured with a discriminant function that outputs similarity scores corresponding to candidate characters for an input character such as an East Asian character. A decision rule selects the most likely class (or classes) from among the candidates, e.g., to output a recognized character.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components for recognizing handwritten input into a class via STC modeling-based recognition.

FIG. 2 is a block diagram showing example components for training to obtain classification data used in STC modeling-based recognition.

FIG. 3 is a flow diagram showing example steps taken to perform STC modeling-based handwriting recognition.

FIG. 4 shows an illustrative example of a computing device into which various aspects of the present invention may be incorporated.

Other advantages may become apparent from the following detailed description when taken in conjunction with the drawings.

### DETAILED DESCRIPTION

Various aspects of the technology described herein are generally directed towards achieving handwritten character recognition accuracy that is similar to the recognition accuracy of MQDF-based approaches, yet with significantly less memory requirements. As will be understood, this is accomplished by semi-tied covariance (STC) modeling and STC-based classifiers.

While various examples are described herein, it should be understood that these are only examples. For example, while handwritten input is described as being recognized by classification as a character, it is understood that any input character symbol or figure, as well as any combination of characters symbols, and/or figures (e.g., words, phrases, sentences, shapes, and so forth) may be recognized as described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and recognition in general.

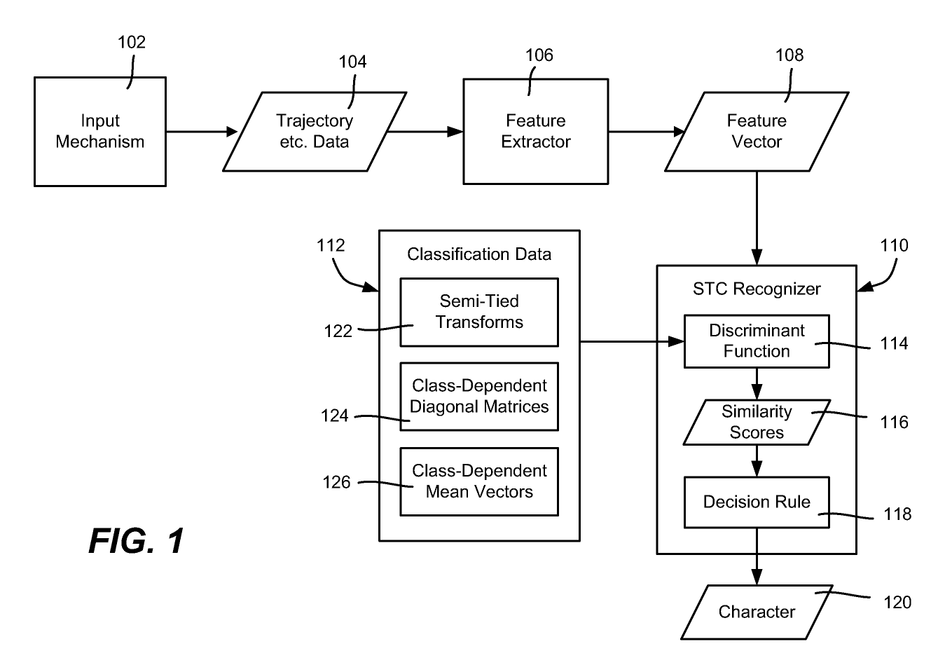

FIG. 1 shows various aspects related to using STC modeling to accomplish handwriting recognition in one implementation. A handwritten character is entered via a suitable input mechanism, such as a touch-screen digitizer 102. The corresponding ink data (e.g., strokes and timing, referred to as trajectory data 104 but possibly including other data) is received at a feature extraction mechanism 106, which outputs a feature vector 108 or the like in a known manner that is representative of the unknown character's features.

In general, an STC recognizer 110 then matches the unknown character's feature vector to feature vectors that represent known characters, e.g., maintained in the form of classification data 112 (such as obtained from training as described below). Note that the feature extraction mechanism 106 may be considered part of the STC recognizer 110.

To recognize a character, the STC recognizer 110 includes an STC discriminant function 114 that produces similarity scores 116, e.g., one for each candidate. A decision rule 118 selects the candidate with the best score and outputs it as a recognized character 120. Note that as with other recognizers, it is feasible to output more than one character depending on the application, e.g., a probability-ranked list of the top N most likely characters.

Unlike prior models, the classification data 112 that is used in the recognition needs significantly less storage than other models such as MQDF. In general, instead of storing a covariance matrix for each character, the classification data 112 comprises one or more sets of common data for all characters, plus a small amount of individual, per-character data. More particularly, the common data comprises a set of semi-tied transforms 122 that is common to the various character classes, while the per-character data comprises class-dependent diagonal matrices 124 and the mean vectors for each class 126.

Thus, the STC modeling technology described herein is able to maintain data representative of the known characters/feature vectors that are to be matched using far less memory; for example, instead of storing 10,000 relatively large covariance matrices for 10,000 characters, only on the order of 32 semi-tied transforms need be stored, (with 10,000 far smaller sets of class-dependent diagonal matrices and the mean vectors).

By adopting semi-tied covariance (STC) modeling, assume that the covariance matrix for each character class Cⱼ takes the following constrained form:

Σⱼ=H_{c(j)}ΩⱼH_{c(j)}^{T} (1)

where Ωⱼ is a class-dependent diagonal matrix, H_{c(j)} is a non-diagonal matrix whose inverse, A_{c(j)}, is referred to as semi-tied transform hereinafter and is shared by a subset of character classes, c(j) is an assignment (or mapping) function that maps character class label j to a tied-transform-cluster label which takes one of the values from the set {1, 2, . . . C}. Consequently, the following discriminant function can be defined as the log-likelihood function of x given STC-based character model parameters ⊖:

$${g}_{j} ( x ; ⊖ ) {=}^{Δ } log \frac{{det A}_{c ( j )}}{\sqrt{det {Ω}_{j}}} - \frac{1}{2} {\sum }_{k = 1}^{d} {w}_{jk}^{2} ( x ) / {σ}_{jk}^{2} \qquad ( 2 )$$

where wⱼₖ(x) is the k-th component of wⱼ(x)=A_{c(j)}(x-μⱼ), σⱼₖ² is the k-th diagonal component of Ωⱼ.

The known maximum discriminant decision rule (shown in FIG. 1 as decision rule 118)

$$x ∈ {C}_{j} if j = arg {max}_{l} {g}_{l} ( x ; {⊖}_{l} )$$

can then be used for character classification. It is noted that only the second term in the above discriminant function need be computed for each unknown observation while the first term can be pre-computed and cached. As for training of STC-based character model parameters ⊖={{μⱼ,Ωⱼ})ⱼ₌₁^{M}, {Aₗ}ₗ₌₁^{C}}, (where M is the number of character classes) maximum likelihood (ML) and/or minimum classification error (MCE) training may be conducted as described below.

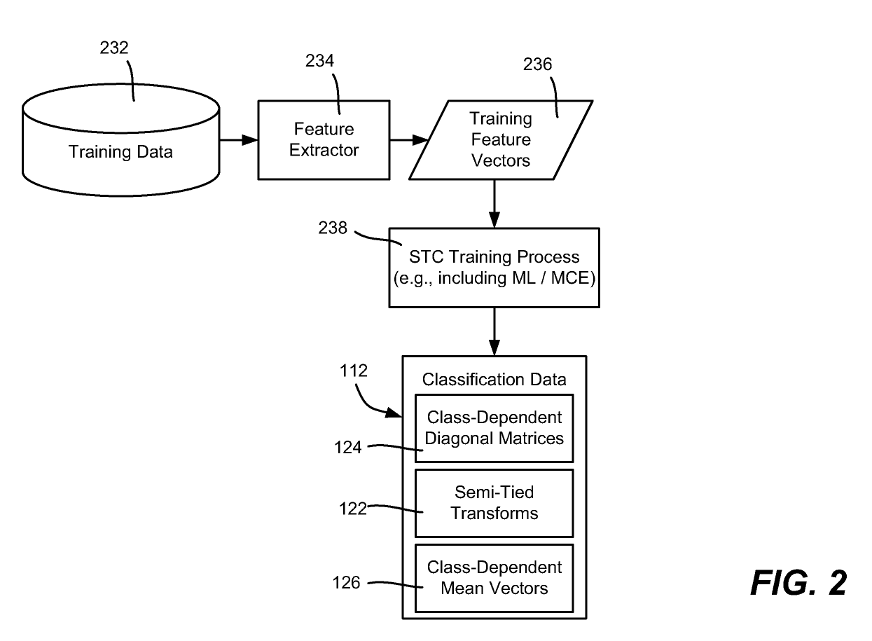

Turning to training, in general, training data 232 (FIG. 2) comprising samples each labeled with the appropriate class, is processed by a feature extractor 234 to produce training feature vectors 236. As described below, the training feature vectors 236 are then used by a STC training process 238 to estimate a mean feature vector 126 and the precision matrix for each character class, from which the diagonal matrices 124, along with the semi-tied transforms 122 are computed.

For ML training, the objective function is defined as follows:

$$ℒ = - \frac{1}{2} {\sum }_{j = 1}^{M} {\sum }_{i = 1}^{{n}_{j}} {( {x}_{i}^{( j )} - {μ}_{j} )}^{T} {P}_{j} ( {x}_{i}^{( j )} - {μ}_{j} ) + {\sum }_{j = 1}^{M} {n}_{j} ( log det {A}_{c ( j )} - \frac{1}{2} log det {Ω}_{j} ) , \qquad ( 3 )$$

where

Pⱼ=A_{c(j)}^{T}Ωⱼ⁻¹A_{c(j)}. (4)

The ML estimate of μⱼ can be derived easily as the sample mean of the training feature vectors from class Cⱼ. Given μⱼ's, optimizing the ML objective function with respect to semi-tied transforms, class-dependent diagonal covariances and assignment function is nontrivial. An example procedure of alternating variables is shown below:

Step 1: Initialization

Randomly generate an assignment function c(j), where j ∈ {1,
2, . . . M}, c(·)∈{1, 2, . . . C}. Set each semi-tied transform
Aₗ as identity matrix. For each class, first calculate the sample
covariance matrix Σ̅ⱼ.

Step 2: Optimizing likelihood function with respect to {Aₗ} and {Ωⱼ} by
fixing assignment function c(·)

Step 2-1: Update Ωⱼ as follows:

(5)

\hat{Ω}ⱼ = diag(A_{c(j)}\tilde{Σ}ⱼA_{c(j)}^{T}).

Step 2-2: For each Aₗ, each row of Aₗ is optimized given the current
value of the other rows. The updating formula for the k-th row of Aₗ,
i.e., aₖ^{(l)}, is as follows:

(6)

${( {\hat{a}}_{k}^{( l )} )}^{T} = {c}_{k}^{{( l )}^{T}} {W}_{k}^{{( l )}^{- 1}} \sqrt{\frac{{ξ}_{l}}{{c}_{k}^{{( l )}^{T}} {W}_{k}^{{( l )}^{- 1}} {c}_{k}^{( l )}}}$

$where {ξ}_{l} = {Σ}_{j : c ( j ) = l} {n}_{j} , and {W}_{k}^{( l )} = {Σ}_{j : c ( j ) = l} \frac{{n}_{j}}{{σ}_{jk}^{2}} {\tilde{Σ}}_{j} , {c}_{k}^{( l )} is$
the k-th column of det(Aₗ)Aₗ⁻¹. By iteratively running through
the rows, the complete transform Aₗ can be updated.
Step 2-3: Repeat step 2-2 N₁ times.
Step 2-4: Repeat step 2-1 to step 2-3 N₂ times.

Step 3: Updating the assignment function by fixing {Aₗ} and {Ωⱼ}

Once the semi-tied transforms Aₗ's are updated, the assignment
function c(·) can be updated as follows:

(7)

$\hat{c} ( j ) = arg {max}_{k} \frac{det {A}_{k}}{\sqrt{det ( diag {A}_{k} {\tilde{Σ}}_{j} {{A}_{k}}^{T} )}} .$

Step 4: Repeat Step 2 to Step 3 N₃ times.

Using the above training procedure, the likelihood function will increase during the optimization process.

Turning MCE training to further improve the accuracy of STC-based classifiers, note that one MCE training procedure is described herein, which is a special case of a known general MCE formulation. Given the discriminant function of STC model in Equation (2) and the decision rule, a misclassification measure for each training sample x in class Cⱼ is defined:

$${d}_{j} ( x ; Θ ) = - {g}_{j} ( x ; {Θ}_{j} ) + {G}_{j} ( x ; Θ ) , \qquad ( 8 )$$

where

$${G}_{j} ( x ; Θ ) = \frac{1}{η} log [ \frac{1}{M - 1} {\sum }_{n , n \neq j} exp [ η {g}_{n} ( x ; {Θ}_{n} ) ] ] . \qquad ( 9 )$$

### Consequently,

$${d}_{j} ( x ; Θ ) = - {g}_{j} ( x ; {Θ}_{j} ) + {max}_{n , n \neq j} {g}_{n} ( x ; {Θ}_{n} ) , \qquad ( 10 )$$

as η→∞. The loss function of a training sample x is then defined as:

$$l ( x ; Θ ) = {\sum }_{j = 1}^{M} \frac{1}{1 + exp [ - α {d}_{j} ( x ; Θ ) + β ]} 1 ( x ∈ {C}_{j} ) , \qquad ( 11 )$$

where α and β are two control parameters, and 1(·) is an indicator function. The parameter ⊖ can be estimated by minimizing the empirical loss

$$\frac{1}{{N}_{tr}} {\sum }_{x ∈ χ} l ( x ; Θ ) ,$$

where Nₜᵣ is the number of samples in training set X. In practice, a sequential gradient descent algorithm can be used to solve this problem with the following parameter updating formula:

$${Θ}_{τ + 1} = {Θ}_{τ} - {ε}_{τ} ∇ l ( {x}_{τ} ; Θ ) {\vert}_{Θ = {Θ}_{τ}} , \qquad ( 12 )$$

where the index “τ” represents the cumulative training samples presented the far (in random order). According to this formula, mean vectors μⱼ are updated as follows:

$${μ}_{j}^{τ + 1} = \{ \begin{matrix}{μ}_{j}^{τ} + {ε}_{τ}^{m} {v}_{τ} {P}_{j} ( {x}_{τ} - {μ}_{j}^{τ} ) & if j = {i}_{τ} \\ {μ}_{j}^{τ} - {ε}_{τ}^{m} {v}_{τ} {κ}_{j τ} {P}_{j} ( {x}_{τ} - {μ}_{j}^{τ} ) & otherwise ,\end{matrix}$$

where i_{τ} is the label of x_{τ}, v_{τ}=l(x_{τ}; ⊖)(1−I(x_{τ}; ⊖)), Pⱼ is the same as defined in Equation (4), ε_{τ}^{m} is a learning rate for mean vector, and

$${κ}_{j τ} = \frac{exp ( η {g}_{k} ( {x}_{τ} ; {Θ}_{j} ) )}{{\sum }_{k \neq {i}_{τ}} exp ( η {g}_{j} ( {x}_{τ} ; {Θ}_{k} ) )}$$

As for updating a class-dependent diagonal matrix Ωⱼ, in order to maintain the constraints σⱼₖ²>0 for all j and k, the procedure transforms σⱼₖ² to a new variable σ̅ⱼₖ=log σⱼₖ² and uses the following equation to update σ̅ⱼₖ

$${\overline{σ}}_{jk}^{τ + 1} = \{ \begin{matrix}{\overline{σ}}_{jk}^{τ} - {ε}_{τ}^{v} {v}_{τ} ( 1 - {e}^{- {\overline{σ}}_{jk}^{τ}} {w}_{jk}^{2} ( {x}_{τ} ) ) & if j = {i}_{τ} \\ {\overline{σ}}_{jk}^{τ} + {ε}_{τ}^{v} {v}_{τ} {κ}_{j τ} ( 1 - {e}^{- {\overline{σ}}_{jk}^{τ}} {w}_{jk}^{2} ( {x}_{τ} ) ) & otherwise ,\end{matrix}$$

where Wⱼₖ² (x) is the same as defined above. After the completion of training, the procedure transforms σ̅ⱼₖ back to its corresponding σⱼₖ².

One pass of all training samples is called an epoch. After the completion of each epoch, the procedure randomizes the ordering of Xagain. Let N_{epoch} denote the number of epochs to be performed. The learning rate ε_{τ}^{m} and ε_{τ}^{v} are set as

$${ε}_{τ}^{m} = {ε}_{0}^{m} ( 1 - \frac{τ}{{N}_{epoch} \times {N}_{tr}} ) , \\ {ε}_{τ}^{v} = {ε}_{0}^{v} ( 1 - \frac{τ}{{N}_{epoch} \times {N}_{tr}} ) ,$$

where ε_{τ}^{m} and ε_{τ}^{v} are two experimentally-determined control parameters. It is noted that the same strategy may be used for MCE training of MQDF parameters.

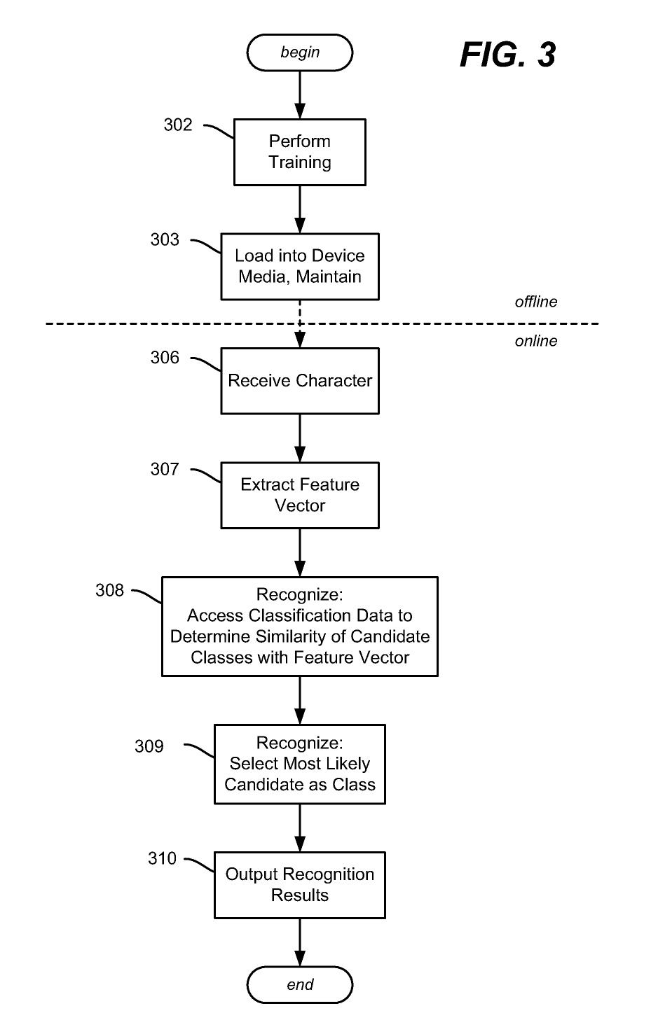

FIG. 3 summarizes various offline (steps 302 and 303) and online (steps 306-310) aspects of the technology, beginning at step 302 which represents the training procedure, which may include maximum likelihood and/or minimum classification error (MCE) operations.

Step 303 represents loading the classification data, e.g., storing it into some media on a computing device that will later perform online recognition. Note that the classification data may be maintained in a compressed form and then decompressed into other device memory when needed.

Steps 306 represents receiving handwritten input in some later, online recognition operating state. As can be readily appreciated, the input may be received at an operating system component that recognizes input and provides an output class for multiple applications, or at an application dedicated to recognition. Step 307 represents extracting the feature vector from the handwritten input.

Steps 308 and 309 perform the recognition, e.g., by accessing the classification data to determine similarity scores for candidate classes (step 308) and by selecting the most likely candidate as the class (or top N candidates in order, if desired, for subsequent automated or user selection of a class). Step 310 represents outputting the recognition results in some way, e.g., providing the class to an application, displaying the results, and so forth.

### Exemplary Operating Environment

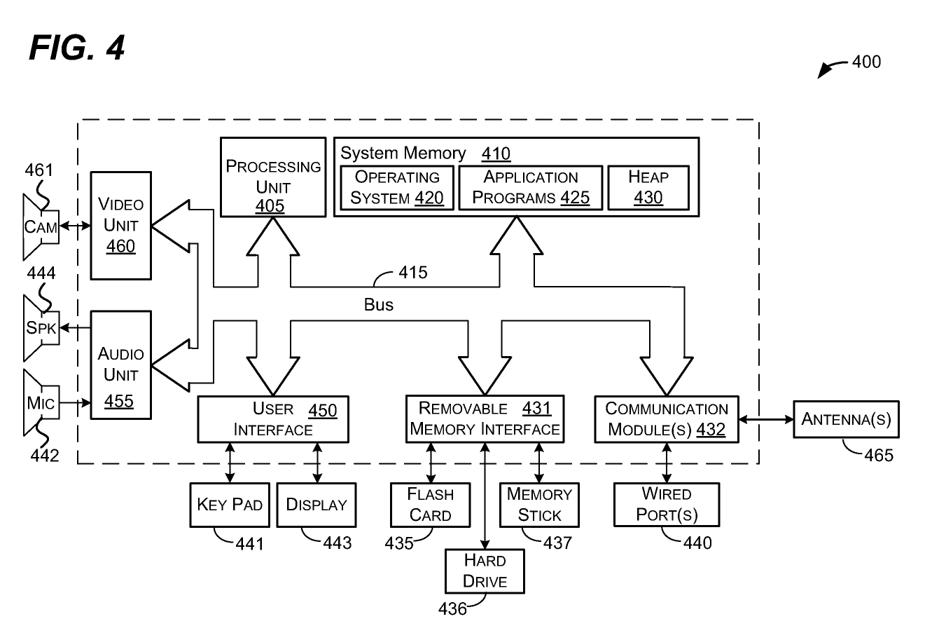

FIG. 4 illustrates an example of a suitable mobile device 400 on which aspects of the subject matter described herein may be implemented. The mobile device 400 is only one example of a device and is not intended to suggest any limitation as to the scope of use or functionality of aspects of the subject matter described herein. Neither should the mobile device 400 be interpreted as having any dependency or requirement relating to any one or combination of components illustrated in the exemplary mobile device 400.

With reference to FIG. 4, an exemplary device for implementing aspects of the subject matter described herein includes a mobile device 400. In some embodiments, the mobile device 400 comprises a cell phone, a handheld device that allows voice communications with others, some other voice communications device, or the like. In these embodiments, the mobile device 400 may be equipped with a camera for taking pictures, although this may not be required in other embodiments. In other embodiments, the mobile device 400 comprises a personal digital assistant (PDA), hand-held gaming device, notebook computer, printer, appliance including a set-top, media center, or other appliance, other mobile devices, or the like. In yet other embodiments, the mobile device 400 may comprise devices that are generally considered non-mobile such as personal computers, servers, or the like.

Components of the mobile device 400 may include, but are not limited to, a processing unit 405, system memory 410, and a bus 415 that couples various system components including the system memory 410 to the processing unit 405. The bus 415 may include any of several types of bus structures including a memory bus, memory controller, a peripheral bus, and a local bus using any of a variety of bus architectures, and the like. The bus 415 allows data to be transmitted between various components of the mobile device 400.

The mobile device 400 may include a variety of computer-readable media. Computer-readable media can be any available media that can be accessed by the mobile device 400 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 400.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, Bluetooth®, Wireless USB, infrared, WiFi, WiMAX, and other wireless media. Combinations of any of the above should also be included within the scope of computer-readable media.

The system memory 410 includes computer storage media in the form of volatile and/or nonvolatile memory and may include read only memory (ROM) and random access memory (RAM). On a mobile device such as a cell phone, operating system code 420 is sometimes included in ROM although, in other embodiments, this is not required. Similarly, application programs 425 are often placed in RAM although again, in other embodiments, application programs may be placed in ROM or in other computer-readable memory. The heap 430 provides memory for state associated with the operating system code 420 and the application programs 425. For example, the operating system 420 and application programs 425 may store variables and data structures in the heap 430 during their operations.

The mobile device 400 may also include other removable/non-removable, volatile/nonvolatile memory. By way of example, FIG. 4 illustrates a flash card 435, a hard disk drive 436, and a memory stick 437. The hard disk drive 436 may be miniaturized to fit in a memory slot, for example. The mobile device 400 may interface with these types of non-volatile removable memory via a removable memory interface 431, or may be connected via a universal serial bus (USB), IEEE 4394, one or more of the wired port(s) 440, or antenna(s) 465. In these embodiments, the removable memory devices 435-137 may interface with the mobile device via the communications module(s) 432. In some embodiments, not all of these types of memory may be included on a single mobile device. In other embodiments, one or more of these and other types of removable memory may be included on a single mobile device.

In some embodiments, the hard disk drive 436 may be connected in such a way as to be more permanently attached to the mobile device 400. For example, the hard disk drive 436 may be connected to an interface such as parallel advanced technology attachment (PATA), serial advanced technology attachment (SATA) or otherwise, which may be connected to the bus 415. In such embodiments, removing the hard drive may involve removing a cover of the mobile device 400 and removing screws or other fasteners that connect the hard drive 436 to support structures within the mobile device 400.

The removable memory devices 435-437 and their associated computer storage media, discussed above and illustrated in FIG. 4, provide storage of computer-readable instructions, program modules, data structures, and other data for the mobile device 400. For example, the removable memory device or devices 435-437 may store images taken by the mobile device 400, voice recordings, contact information, programs, data for the programs and so forth.

A user may enter commands and information into the mobile device 400 through input devices such as a key pad 441 and the microphone 442. In some embodiments, the display 443 may be touch-sensitive screen and may allow a user to enter commands and information thereon. The key pad 441 and display 443 may be connected to the processing unit 405 through a user input interface 450 that is coupled to the bus 415, but may also be connected by other interface and bus structures, such as the communications module(s) 432 and wired port(s) 440.

A user may communicate with other users via speaking into the microphone 442 and via text messages that are entered on the key pad 441 or a touch sensitive display 443, for example. The audio unit 455 may provide electrical signals to drive the speaker 444 as well as receive and digitize audio signals received from the microphone 442.

The mobile device 400 may include a video unit 460 that provides signals to drive a camera 461. The video unit 460 may also receive images obtained by the camera 461 and provide these images to the processing unit 405 and/or memory included on the mobile device 400. The images obtained by the camera 461 may comprise video, one or more images that do not form a video, or some combination thereof.

The communication module(s) 432 may provide signals to and receive signals from one or more antenna(s) 465. One of the antenna(s) 465 may transmit and receive messages for a cell phone network. Another antenna may transmit and receive Bluetooth® messages. Yet another antenna (or a shared antenna) may transmit and receive network messages via a wireless Ethernet network standard.

In some embodiments, a single antenna may be used to transmit and/or receive messages for more than one type of network. For example, a single antenna may transmit and receive voice and packet messages.

When operated in a networked environment, the mobile device 400 may connect to one or more remote devices. The remote devices may include a personal computer, a server, a router, a network PC, a cell phone, a media playback device, a peer device or other common network node, and typically includes many or all of the elements described above relative to the mobile device 400.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server is often used herein, it will be recognized that this term may also encompass a client, a set of one or more processes distributed on one or more computers, one or more stand-alone storage devices, a set of one or more other devices, a combination of one or more of the above, and the like.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a method comprising, maintaining semi-tied transforms shared by classes, maintaining a class-dependent diagonal matrix and a mean vector corresponding to each class, receiving handwritten input, and classifying the handwritten input based upon the per-class diagonal matrices and the semi-tied transforms.

2. The method of claim 1 further comprising, extracting features of the handwritten input.

3. The method of claim 1 further comprising, performing training to obtain the semi-tied transforms, the class-dependent diagonal matrices and mean vectors.

4. The method of claim 3 wherein performing the training includes conducting maximum likelihood training to find model parameters.

5. The method of claim 3 wherein performing the training includes conducting minimum classification error training.

6. The method of claim 3 wherein training to obtain the semi-tied transforms includes processing data corresponding to a covariance matrix for each class into a set of semi-tied transforms.

7. The method of claim 6 wherein the data corresponding to the covariance matrix comprises a precision matrix.

8. In a computing environment, a system comprising, a feature extractor that obtains a feature vector from handwritten input, and a semi-tied covariance model recognizer that accesses semi-tied transforms shared by classes and a class-dependent diagonal matrix and a mean vector corresponding to each class, to classify the handwritten input as at least one class.

9. The system of claim 8 wherein the recognizer classifies the handwritten input as at least one East Asian character.

10. The system of claim 8 wherein the semi-tied covariance model recognizer includes a discriminant function that outputs similarity scores corresponding to candidate characters.

11. The system of claim 8 further comprising means for obtaining the semi-tied transforms and the class-dependent diagonal matrices.

12. The system of claim 11 wherein the means for obtaining the semi-tied transforms and the class-dependent diagonal matrices includes means for processing a precision matrix for each class into the semi-tied transforms and the class-dependent diagonal matrices.

13. The system of claim 11 wherein the means for obtaining semi-tied transforms, the class-dependent diagonal matrices and the mean vectors includes maximum likelihood training means.

14. The system of claim 11 wherein the means for obtaining the semi-tied transforms, the class-dependent diagonal matrices and the mean vectors includes minimum classification error training means.

15. The system of claim 8 wherein the recognizer semi-tied transforms and the class-dependent diagonal matrices are maintained in a hand-held computing device.

16. One or more computer-readable media having computer-executable instructions, which when executed perform steps, comprising, receiving handwritten input, and recognizing the handwritten input as a class, including by determining similarity of data corresponding to features of the input with classification data by accessing semi-tied transforms shared by classes, class-dependent diagonal matrices and mean vectors having a class-dependent diagonal matrix and a mean vector corresponding to each class, in order to classify the handwritten input as the class.

17. The one or more computer-readable media of claim 16 having further computer-executable instructions comprising, loading the semi-tied transforms and class-dependent diagonal matrices from a first computing device into a second computing device that includes the computer-readable media.

18. The one or more computer-readable media of claim 16 wherein the class that is recognized comprises an East Asian character.

19. The one or more computer-readable media of claim 16 wherein recognizing the handwritten input comprises executing a discriminant function to produce the similarity data.

20. The one or more computer-readable media of claim 16 wherein recognizing the handwritten input further comprises executing a decision rule that processes the similarity data to select the class.
